(19) United States
(12) Patent Application Publication
(10) Pub. No.: US 2013/0160135 A1
(43) Pub. Date: Jun. 20, 2013

(54) METHOD AND APPARATUS FOR PERFORMING DOWNLOADABLE DIGITAL RIGHTS MANAGEMENT FOR A CONTENT SERVICE

(71) Applicant: Samsung Electronics Co., Ltd., Gyeonggi-do (KR)

(72) Inventors: Sergey Nikolayevich SELEZNEV, Gyeonggi-do (KR); Byung Rae Lee, Seoul (KR)

(73) Assignee: Samsung Electronics Co., Ltd., Gyeonggi-do (KR)

(21) Appl. No.: 13/719,936

(22) Filed: Dec. 19, 2012

(30) Foreign Application Priority Data
Dec. 19, 2011 (KR) 10-2011-0137252

(51) Int. Cl. G06F 21/10

(52) U.S. Cl. CPC G06F 21/10
USPC 726/26

(57) ABSTRACT

A method and system are provided for performing downloadable Digital Rights Management (DRM) for a content service. The method includes receiving, from a service provider, a Content Access Token (CAT) issuance request for specific content, wherein the CAT issuance request includes information about devices mapped to account information of a user that has purchased the specific content; issuing a CAT; and delivering the CAT to the devices mapped to the account information.

### PRIORITY

This application claims priority under 35 U.S.C. §119(a) to Korean Patent Application Serial No. 10-2011-0137252, which was filed in the Korean Intellectual Property Office on Dec. 19, 2011, the entire disclosure of which is incorporated herein by reference.

### BACKGROUND OF THE INVENTION

1. Field of the Invention

The present invention relates generally to a method and apparatus for performing downloadable Digital Rights Management (DRM) for a content service.

2. Description of the Related Art

General DRM refers to technology for preventing the illegal replication and distribution of digital content, wherein only authorized users are permitted to enjoy the content, and for managing copyrights of digital content through user management, billing services, etc. Specifically, using DRM, authorized users having a specific encryption key may enjoy DRM-protected content by decrypting it with the encryption key.

As for downloadable DRM technology, its standardization is now underway in Open Internet Protocol Television Forum (OIPF) and the like.

For example, using conventional downloadable DRM technology, when a device intends to reproduce DRM-protected content, the device sends a request for the content and the DRM to an Internet Protocol Television (IPTV) main server, and then pays a billing server for the content. The device then acquires a Content Access Token (CAT) for the content from the billing server. Thereafter, the device sends a DRM Software (SW) download request for the content to an SW download server together with the CAT. In response, the SW download server sends DRM SW for the content to the device. Upon receiving the DRM SW, the device installs the DRM SW and reproduces the encrypted content.

However, the above-described conventional downloadable DRM technology may only be used for a single device and a single DRM. Consequently, using conventional downloadable DRM technology, a user cannot enjoy a plurality of digital content and from a plurality of DRM solution providers.

### SUMMARY OF THE INVENTION

Accordingly, the present invention is designed to address at least the problems and/or disadvantages described above and to provide at least the advantages described below.

An aspect of the present invention is to provide a method and apparatus for performing downloadable DRM when there is a plurality of devices using a same user account and there is a plurality of downloadable DRMs supporting the content, which has been purchased using the same user account.

Another aspect of the present invention is to provide a method and apparatus for performing CAT synchronization between a plurality of devices, when there is the plurality of devices using the same user account.

Another aspect of the present invention is to provide a method and apparatus for downloading DRM designated by a specific device, when there is a plurality of downloadable DRMs supporting the content requested by the specific device, which has undergone CAT synchronization.

In accordance with an aspect of the present invention, a method for performing downloadable DRM for a content service is provided. The method includes receiving, from a service provider, a Content Access Token (CAT) issuance request for specific content, wherein the CAT issuance request includes information about devices mapped to account information of a user that has purchased the specific content; issuing a CAT; and delivering the CAT to the devices mapped to the account information.

In accordance with another aspect of the present invention, a method for performing downloadable DRM for a content service is provided. The method includes receiving, from a Content Access Token (CAT) server, a CAT issued for specific content that has been purchased; determining whether DRM software is supported, using information about the DRM software supporting the specific content, the information about the DRM software being included in the CAT; and transmitting, if the DRM software is not supported, the CAT further including the information about the DRM software to be downloaded and a DRM software download request, to a DRM server.

In accordance with another aspect of the present invention, a Content Access Token (CAT) server for performing downloadable Digital Rights Management (DRM) for a content service is provided. The CAT server includes a receiver that receives, from a service provider, a CAT issuance request for specific content, wherein the CAT issuance request includes information about devices mapped to account information of a user that has purchased the specific content; an issuer that issues a CAT; and a transmitter that transmits the CAT to the devices.

In accordance with another aspect of the present invention, a device is provided for performing downloadable DRM for a content service. The device includes a receiver that receives, from a Content Access Token (CAT) server, a CAT issued for specific content that has been purchased; a controller that determines whether DRM software is supported in the device, using information about the DRM software that supports the specific content, the information about the DRM software being included in the CAT; and a transmitter that transmits the CAT further including information about the DRM software to be downloaded and a DRM software download request, to a DRM server, if the DRM software is not supported in the device.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 illustrates a DRM system according to an embodiment of the present invention;

FIG. 2 illustrates a method of downloading DRM by a CAT-synchronized device in a DRM system according to an embodiment of the present invention;

FIG. 3 illustrates an example of a CAT according to an embodiment of the present invention;

FIG. 4 is a flowchart illustrating a method of a CAT server according to an embodiment of the present invention; and

FIG. 5 is a flowchart illustrating a method of downloading DRM by a CAT-synchronized device according to an embodiment of the present invention.

### DETAILED DESCRIPTION OF EMBODIMENTS OF THE INVENTION

Various embodiments of the present invention will now be described in detail with reference to the accompanying drawings. In the following description, specific details such as detailed configuration and components are merely provided to assist the overall understanding of these embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

Additionally, although the embodiments of the present invention will be described herein, based on the environment where there is a plurality of devices using the same user account and there is a plurality of DRMs, the embodiments are not necessarily limited thereto.

In accordance with an embodiment of the present invention, CAT synchronization is performed. Specifically, a user acquires a CAT for content that has been purchased on any one of the plurality of devices, using the user account. When purchasing the content, information about the plurality of devices is delivered to a CAT server. Accordingly, CAT synchronization can be performed, wherein the CAT for the purchase-completed content is delivered to the remaining devices among the plurality of devices.

In accordance with another embodiment of the present invention, a method and apparatus are provided for downloading DRM supporting the purchase-completed content, after CAT synchronization is completed. The CAT according to an embodiment of the present invention may further include additional information about the DRM that the device will download. Based on the additional information, the device may acquire information about the DRM it will download, may designate a DRM it desires to download, and may download the designated DRM SW.

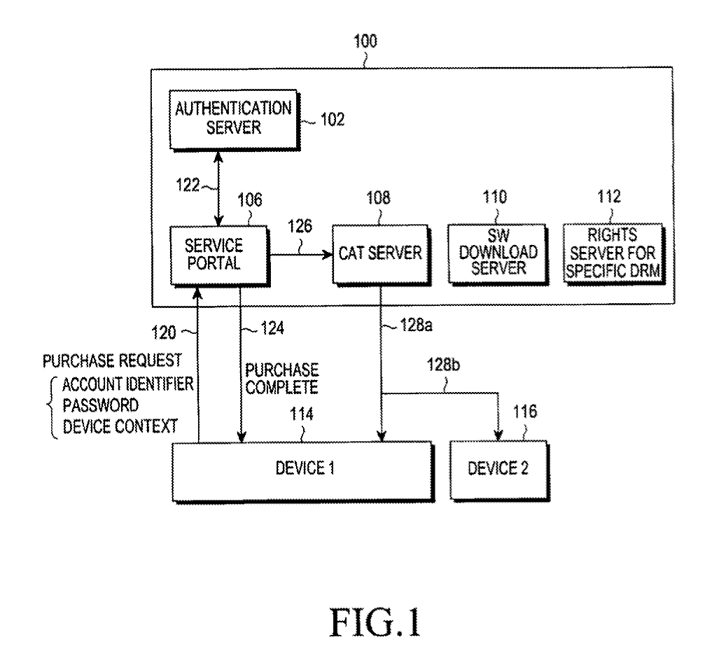

FIG. 1 illustrates a DRM system according to an embodiment of the present invention.

Referring to FIG. 1, the DRM system includes a DRM apparatus 100, a first device 114, and a second device 116.

The DRM apparatus 100 includes an authentication server 102, a service portal 106, a CAT server 108, an SW download server 110, and a rights server for specific DRM 112. The authentication server 102 stores account information of each user. For example, the account information can be set in advance by the user and includes an account IDentifier (ID) of the user and a password mapped thereto.

In accordance with an embodiment of the present invention, when the user sets up an account, the authentication server 102 registers information about a plurality of devices, e.g., the first device 114 and the second device 116, which can use the account. Accordingly, the account information of each user includes an account identifier set by the user, a password mapped to the account identifier, and a device context for each of the plurality of devices that can use the account identifier. For example, the device context includes identifier, version, and capability information of each of the devices.

The authentication server 102 performs an authentication operation by determining whether authentication information (i.e., an account identifier of the user, a password, and a device context) received from the service portal 106 is identical to the stored account information.

The service portal 106 requests the authentication server 102 to perform an authentication procedure for the device that has requested purchase of the content, and then serves or provides the content to the device, if it is determined that the authentication procedure is successful.

Upon receiving a CAT issuance request for a device that has requested the content, from the service portal 106, the CAT server 108 issues a CAT to the device, and manages CATs issued to each device.

The SW download server 110 delivers DRM SW for the content requested by the device, to the device. Based on additional information included in the CAT transmitted by the device, the SW download server 110 checks information about the DRM requested by the device, and delivers DRM SW corresponding to the check results to the device.

Thereafter, the rights server for specific DRM 112 manages a license and rights for the specific DRM, and delivers the license and rights to a relevant device.

### First Embodiment (CAT Synchronization)

In a first embodiment of the present invention, it will be assumed that a certain user with an account accesses the service portal 106 through a first device 114 and a second device 116. The first and second devices 114 and 116, which are terminals capable of reproducing content provided by the service portal 160, include, for example, desktop computers, laptop computers, smart TVs, tablet computers, smart phones, etc.

The first embodiment of the present invention provides a way to perform CAT synchronization so that a user who has purchased content on a specific device using his/her own user account may enjoy the content even on the other devices using the user account.

For example, the user attempts to purchase content provided by the service portal 106 on the first device 114 using his/her user account. Referring to FIG. 1, the first device 114, sends a purchase request for the content to the service portal 106 in step 120, the purchase request includes account information of the user. Specifically, the account information includes an account identifier of the user, a password, and a device context of the first device 114. The device context includes identifier, version and capability information of the first device 114. Herein, it is assumed that both the first and second devices 114 and 116 are capable of using the account identifier.

In step 122, the service portal 106 forwards the purchase request to the authentication server 102, which determines the presence or absence of an account identifier acquired from the purchase request. When the account identifier exists, the authentication server 102 determines whether an authorized user is using the first device 114, by verifying whether a password acquired from the purchase request corresponds to the password mapped to the stored account identifier. When the verification is successful, the authentication server 102 sends device contexts mapped to the account identifier to the service portal 106. In step 124, the service portal 106 notifies the first device 114 of the completion of the purchase request.

In step 126, the service portal 106 sends a CAT request for the first device 114 to the CAT server 108. The CAT request includes device contexts mapped to the account identifier, which are acquired from the authentication server 102. Having acquired the device contexts, the CAT server 108 determines the presence of other devices capable of using the account identifier. Here, the CAT server 108 recognizes that the second device 116 may also use the account identifier. Therefore, in steps 128a and 128b, the CAT server 108 delivers a CAT for the purchase-completed content to the first device 114 and to the second device 116. Accordingly, the first and second devices 114 and 116 receive the CAT and are CAT-synchronized with each other.

### Second Embodiment (DRM Download)

A second embodiment of the present invention provides a way in which in a CAT synchronized state Further, the first and second devices 114 and 116 using the same user account can download DRM SW for the purchase-completed content and secure a license for the DRM SW. For example, the first device 114 further inserts additional information for DRM to be downloaded into a CAT proposed by an embodiment of the present invention, and downloads DRM SW corresponding to the additional information.

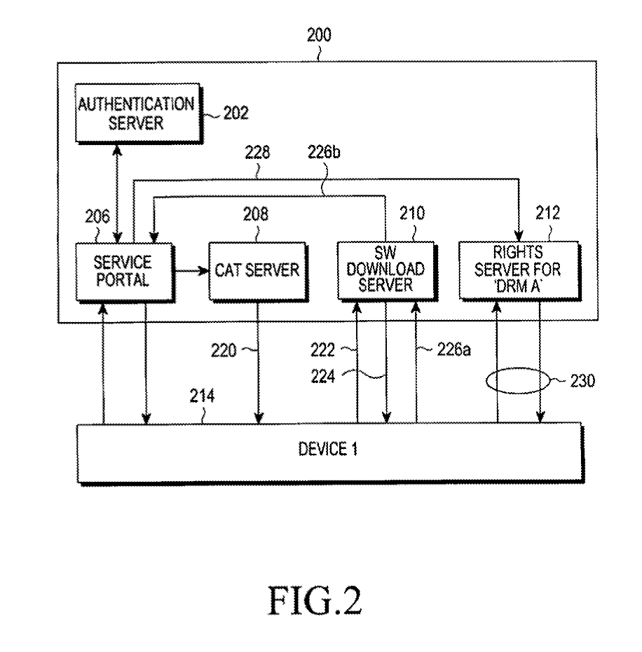

FIG. 2 illustrates a method of downloading DRM by a CAT-synchronized device in a DRM system according to an embodiment of the present invention.

Referring to FIG. 2, a DRM apparatus 200 includes an authentication server 202, a service portal 206, a CAT server 208, an SW download server 210, and a rights server for DRM A (hereinafter referred to as a ‘DRM_A rights server’) 212. The authentication server 202, the service portal 206, the CAT server 208, the SW download server 210, and the DRM_A rights server 212 are the same in operation as the corresponding components of the DRM system illustrated in FIG. 1, and described above. Accordingly, a repetitive detailed description thereof will be omitted herein.

After a CAT synchronized state As an example, a CAT synchronized state will be considered in which a first device 214 has received a CAT for purchase-completed content and other devices using the same account identifier as that of the first device 214 also have received the CAT. The CAT synchronized state is achieved as done in steps 120 to 128a and 128b in FIG. 1, so a detailed description thereof will be omitted for simplicity.

In accordance with the second embodiment of the present invention, the devices in the CAT synchronized state may acquire additional information about DRM to be downloaded, from the CAT acquired from the CAT server 208, set response information for the additional information, and deliver the response information to the SW download server 210. The CAT according to the second embodiment of the present invention includes the following additional information about DRM in its existing ‘Reserved’ field.

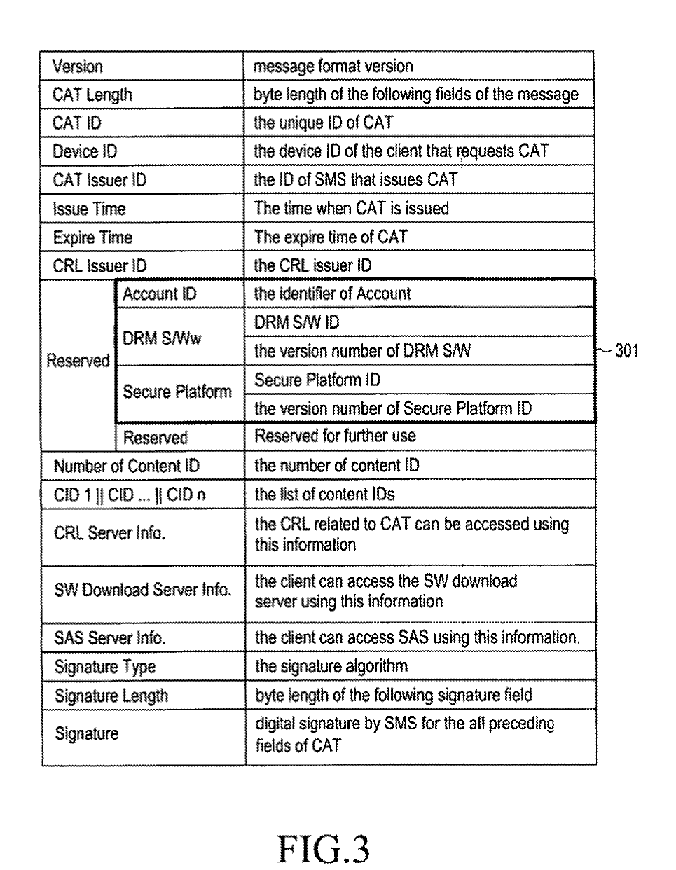

FIG. 3 illustrates an example of a CAT structure according to an embodiment of the present invention.

Referring to FIG. 3, the CAT includes parameters, i.e., Version, CAT Length, CAT ID, Device ID, CAT Issuer ID (indicating an ID of a device having issued the CAT), Issue Time (indicating an issue time of the CAT), Expire Time, Certificated Revocation List (CRL) Issuer ID, Number of Content ID (indicating the number of IDs of purchase-completed content), a list of content IDs of purchase-completed content, CRL Server Info, SW Download Server Info, Subscriber Authentication Server (SAS) Server Info, Signature Type, Signature Length, and Signature. The above parameters included the CAT are the same as those included in a conventional CAT, so a detailed description of these parameters will not be provided herein.

In accordance with an embodiment of the present invention, the CAT also includes additional information 301 about DRM for the purchase-completed content in its ‘Reserved’ field. Specifically, the CAT server 208 sets the additional information 301 for DRM of the purchase-completed content, in a CAT issued for the purchase-completed content. In the example of FIG. 3, the additional information 301 includes the parameters Account ID, DRM S/Ww, and Secure Platform. The information about the required DRM SW includes a DRM SW ID and a version number of the DRM SW.

When there is a plurality of purchase-completed content, the CAT server 208 may issue a CAT for each of the plurality of content separately, or may include, in one CAT, identification information of the plurality of content and DRM SW information for each of the plurality of content.

Upon receiving the set CAT, a device may determine DRM for the purchase-completed content, based on SW information included in the CAT. If there is a plurality of DRMs for the purchase-completed content, the device may designate the DRM supported by the device itself, and set additional information about the designated DRM in the ‘Reserved’ field of the CAT. As an example, the additional information may include, for example, an account identifier, information about the required DRM SW, and a secure platform.

As another example, if there is a plurality of DRM SWs supportable by the device, the device may set information about each of the supportable DRM SWs, for each CAT, or may include all information about each of the supportable DRM SWs in one CAT.

The ‘Reserved’ field may further include a sub Reserved field that is capable of including values for other uses.

Referring again to FIG. 2, in step 220, a first device 214 determines DRM information for the purchase-completed content based on the ‘Reserved’ field of the CAT received from the CAT server 208. Specifically, based on the ‘Reserved’ field of the CAT, the first device 214 determines requirements for downloading DRM SW for the purchase-completed content, i.e., determines whether it supports the secure platform and DRM. When the DRM for the content is already supported internally, i.e., the device 214 already has the required software, the first device 214 notifies the SW download server 210 that the DRM for the content is already supported. In this case, the first device 214 proceeds to step 226b, omitting steps 224 to 226a.

However, when the DRM for the content is already supported internally, in step 222, the first device 214 sends a download request for DRM SW for the content request to the SW download sever 210. For example, the download request for the DRM SW includes the CAT, and a response corresponding to requirements included in the ‘Reserved’ field of the CAT. As for the response, when there is a plurality of DRMs for the purchase-completed content, the first device 214 may designate DRM SW to be downloaded, and the response then includes information about the designated DRM SW, secure platform information, and information about the integrity in the first device 214.

In step 224, the SW download server 210 determines information about the designated DRM SW, included in the ‘Reserved’ field of the CAT. When the designated DRM SW exists, the SW download server 210 transmits the designated DRM SW to the first device 214. When no DRM SW corresponds to the designated DRM in the ‘Reserved’ field of the CAT, the SW download server 210 may transmit another DRM SW capable of supporting the DRM to the first device 214.

In step 226a, the first device 214 successfully installs the DRM SW received from the SW download server 210, and notifies the SW download server 210 of the successful installation of the DRM SW. For example, the information used to notify the successful installation of the DRM SW includes an identifier of the DRM installed by the first device 214, and an identifier of the first device 214.

In step 226b, the SW download server 210 delivers an identifier of the DRM installed by the first device 214, an identifier of the first device 214, and a content identifier, to the service portal 206. For example, herein, an identifier of the DRM installed by the first device 214 is ‘DRM A’.

In step 228, the service portal 206 sends a license acquisition procedure execution instruction message to the DRM_A rights server 212 for the DRM A corresponding to the identifier of the received DRM. The license acquisition procedure execution instruction message includes an identifier of the first device 214 and an identifier of the content.

In step 230, the DRM_A rights server 212 prepares to play the content by performing a license acquisition procedure with the first device 214.

Similarly, although not shown in the drawing, if there is a second device that is CAT-synchronized with the first device 214, the second device does not need to separately perform steps 120 to 126 in FIG. 1, because the second device has already acquired the CAT. Therefore, according to an embodiment of the present invention, the second device may also download DRM for the content that the user has purchased, by performing steps 222 to 230 in FIG. 2, and may then reproduce the content.

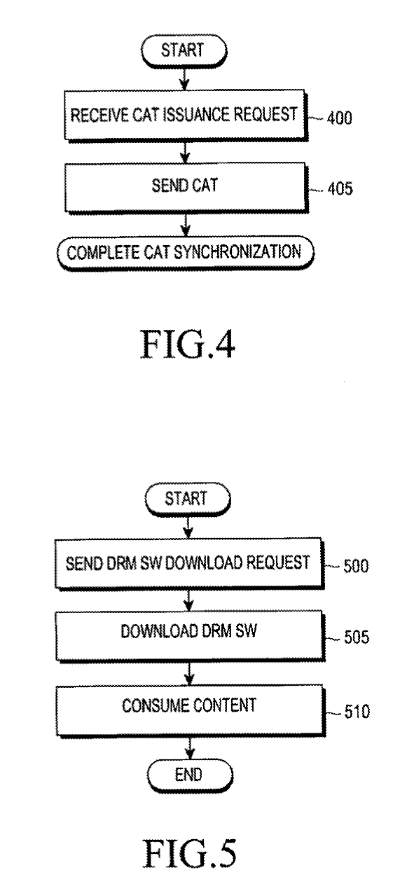

FIG. 4 is a flowchart illustrating a method of a CAT server according to an embodiment of the present invention in which it is assumed that a user enjoys the content he/she has purchased using his/her own user account information, on a plurality of devices. Specifically, FIG. 4 illustrates operations of the CAT server when performing CAT synchronization for a plurality of device.

Referring to FIG. 4, the CAT server receives a CAT issuance request for specific content from a service portal in step 400. The CAT issuance request includes user account information of the user that has purchased the specific content, and information about devices mapped thereto.

In step 405, the CAT server issues a CAT for the specific content, and transmits the CAT to each of the devices it has acquired in response to the CAT issuance request. The CAT further includes additional information for DRM for the specific content. The additional information includes, for example, account information of the user, version numbers and identifiers of DRM SWs supporting the DRM for the specific content, and a version number and an identifier of the secure platform.

FIG. 5 is a flowchart illustrating a method of downloading DRM by a CAT-synchronized device according to an embodiment of the present invention. Specifically, in FIG. 5, it is assumed that a device is in a CAT synchronized state in which the device has received a CAT for the content that its user has purchased on another device using the same user account. The CAT includes additional information for the DRM for specific content as illustrated in FIG. 3. The additional information includes, for example, account information of the user, version numbers and identifiers of DRM SWs supporting the DRM for the specific content, and a version number and an identifier of the secure platform.

Referring to FIG. 5, the device sends a DRM SW download request for the purchase-completed content to an SW download server in step 500. The DRM SW download request includes a CAT that includes response information corresponding to the additional information included in the CAT. For example, the device designates DRM SW to be downloaded among DRM SWs included in the CAT received from the CAT server, and sets a version number and an identifier of the designated DRM SW, and a version number and an identifier of the secure platform, in the ‘Reserved’ field of the CAT to be transmitted to the SW download server. Alternatively, when the DRM for the specific content is already supported in the device, the device may include information notifying it in the response information. In this case, the device does not have to transmit the CAT that includes information about DRM SW, to the SW download server.

In step 505, the device downloads the DRM SW, and if the download is completed successfully, the device notifies the SW download server of the successful download.

Thereafter, if the notification is delivered to the service portable through the SW download server, the license acquisition procedure for the DRM is completed. Thereafter, the device may consume (or reproduce) the specific content in step 510.

As is apparent from the foregoing description, embodiments of the present invention are provided, which perform CAT synchronization between a plurality of devices, in an environment in which the plurality of devices use a same user account, and there is a plurality of downloadable DRMs supporting the content that has been purchased using the same user account. Therefore, each of the plurality of devices may directly perform a procedure for downloading DRM for the purchase-completed content, without separately performing the procedure for acquiring a CAT. If there is a plurality of downloadable DRMs supporting the purchase-completed content, the device separately designates its supportable DRM, making it possible to download the designated DRM.

While the present invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A method for performing downloadable Digital Rights Management (DRM) for a content service, the method comprising:
receiving, from a service provider, a Content Access Token (CAT) issuance request for specific content, wherein the CAT issuance request includes information about devices mapped to account information of a user that has purchased the specific content;
issuing a CAT; and
delivering the CAT to the devices mapped to the account information.

2. The method of claim 1, wherein the CAT includes an account identifier of the user, and an identifier and a version number of DRM software supporting the specific content.

3. The method of claim 2, further comprising:
if the specific content includes a plurality of content, issuing a CAT corresponding to each of the plurality of content; and
delivering each of the issued CATs to the devices along with an account identifier of the user, and an identifier and a version number of DRM software supporting a respective content.

4. The method of claim 2, wherein the specific content includes a plurality of content and the issued CAT is issued for the plurality of content, further comprising:
delivering, with the CAT, an account identifier of the user, and identifiers and version numbers of DRM software supporting the plurality of content.

5. A method for performing downloadable Digital Rights Management (DRM) for a content service, the method comprising:
receiving, from a Content Access Token (CAT) server, a CAT issued for specific content that has been purchased;
determining whether DRM software is supported, using first information about the DRM software supporting the specific content, which is being included in the CAT; and
transmitting, if the DRM software is not supported, the CAT further including second information for downloading the DRM software and a DRM software download request, to a DRM server.

6. The method of claim 5, wherein the second information includes an identifier and version information of at least one DRM software.

7. The method of claim 5, wherein the CAT received from the CAT server further includes an account identifier of a user and a secure platform.

8. A Content Access Token (CAT) server for performing downloadable Digital Rights Management (DRM) for a content service, the CAT server comprising:
a receiver that receives, from a service provider, a CAT issuance request for specific content, wherein the CAT issuance request includes information about devices mapped to account information of a user that has purchased the specific content;
a controller that issues a CAT; and
a transmitter that transmits the CAT to the devices.

9. The CAT server of claim 8, wherein the CAT includes an account identifier of the user, and an identifier and a version number of DRM software supporting the specific content.

10. The CAT server of claim 9, wherein when the specific content includes a plurality of content, the issuer issues a CAT for each of the plurality of content, and the transmitter transmits the issued CATs to the devices along with an account identifier of the user, and an identifier and a version number of DRM software supporting a respective content.

11. The CAT server of claim 9, wherein when the specific content includes a plurality of content, the issuer issues the CAT for the plurality of specific content, and the transmitter delivers the CAT to the devices along with an account identifier of the user, and identifiers and version numbers of DRM software supporting the plurality of content.

12. A device for performing downloadable Digital Rights Management (DRM) for a content service, the device comprising:
a receiver that receives, from a Content Access Token (CAT) server, a CAT issued for specific content that has been purchased;
a controller that determines whether DRM software is supported in the device, using first information about the DRM software that supports the specific content, is the first information being included in the CAT; and
a transmitter that transmits the CAT further including second information for downloading the DRM software and a DRM software download request, to a DRM server.

13. The device of claim 12, wherein the second information includes an identifier and version information of at least one DRM software.

14. The device of claim 12, wherein the CAT received from the CAT server further includes an account identifier of a user and a secure platform.
